(19) United States
(12) Patent Application Publication
(10) Pub. No.: US 2026/0043697 A1
(43) Pub. Date: Feb. 12, 2026

(54) INTEGRATED CIRCUIT STRESS SENSOR

(71) Applicant: TEXAS INSTRUMENTS INCORPORATED, Dallas, TX (US)

(72) Inventors: Michael Szelong, Freising (DE); Tobias Fritz, Mainburg (DE)

(21) Appl. No.: 18/801,056

(22) Filed: Aug. 12, 2024

(51) Int. Cl. G01L 1/22

(52) U.S. Cl. CPC G01L 1/2293; G01L 1/225

(57) ABSTRACT

An apparatus is described which includes a semiconductor substrate and a shear stress sensor including first diffusion regions in the semiconductor substrate, in which the first diffusion regions are symmetrical over a first axis and a second axis. The first and second axes being orthogonal to each other. The apparatus further comprises normal stress sensors including a second diffusion region in the semiconductor substrate.

### BACKGROUND

A stress sensor can be used to measure or sense stress on the surface of a device under test (DUT). Some stress sensor may include resistors to sense/measure the stress. Integrating the resistors within a semiconductor package can present challenges.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1A is a schematic illustrating a perspective view of an apparatus having a stress sensor on a device under test (DUT), in accordance with at least one example.

FIG. 1B is a schematic illustrating a side view of the apparatus of FIG. 1A, in accordance with at least one example.

FIG. 2 is a schematic illustrating a cross-section of a stress sensor in a semiconductor diffusion, in accordance with at least one example.

FIG. 3 is a schematic illustrating a top view of a stress sensor comprising a shear stress sensor and a set of normal stress sensors, in accordance with at least one example.

FIGS. 4A-B are schematics illustrating read-out circuitry for diffusion sensors configured as resistor bridges, in accordance with at least some examples.

FIG. 4C is a schematic illustrating a read-out mechanism for a selectable diffusion sensor against a reference, in accordance with at least one example.

FIG. 5 is a schematic illustrating a stress sensor with shear stress sensor and a set of normal stress sensors having a combination of metal and diffusion components, in accordance with at least one example.

FIG. 6 is a schematic illustrating a portion of a cross-section of the stress sensor of FIG. 5, in accordance with at least one example.

FIG. 7 is a schematic illustrating a stress sensor with shear stress sensor and a set of normal stress sensors having mainly diffusion components, in accordance with at least one example.

FIG. 8 is a schematic illustrating a diffusion resistor with wider interconnect regions connecting straight diffusion regions, in accordance with at least one example.

FIG. 9 is a schematic illustrating a shear sensor including the example diffusion resistor of FIG. 8, in accordance with at least one example.

FIGS. 10A-B are schematics illustrating a normal stress sensor and symmetric L-shaped diffusion regions, respectively, in accordance with at least one example.

FIG. 11 is a schematic illustrating a top view of a normal diffusion sensor with kelvin connections, in accordance with at least one example.

FIG. 12 is a schematic illustrating a side view of FIG. 11 with a read-out mechanism coupled to kelvin connections, in accordance with at least one example.

### SUMMARY

In at least one example, an apparatus is provided which comprises a semiconductor substrate. In at least one example, the apparatus comprises a shear stress sensor including first diffusion regions in the semiconductor substrate, in which the first diffusion regions are symmetrical over a first axis and a second axis, the first and second axes being orthogonal to each other. In at least one example, the apparatus comprises normal stress sensors including a second diffusion region in the semiconductor substrate.

In at least one example, an integrated circuit is provided which comprises a semiconductor substrate having first and second diffusion regions. The first diffusion regions are configured to conduct a current along a first direction along a surface of the semiconductor substrate, while the second diffusion regions are configured to conduct a current along a second direction along the surface. In at least one example, the first and second directions are angled from each other. In at least one example, at least one of the first or second diffusion regions are symmetrical over a first axis and a second axis, the first axis and the second axis being orthogonal to each other. In at least one example, the integrated circuit comprises a readout circuitry coupled to the first and second diffusion regions and configured to provide signals representing respective resistances of the first and second regions.

### DETAILED DESCRIPTION

In at least one example, a stress sensor integrated circuit (IC) is provided which uses piezoresistive effect to sense compressive, tensile, and/or shear stress on a device under test (DUT). The DUT can be any device that can deform under stress, such as a shaft, another IC, etc. In at least one example, the stress sensor IC comprises resistors formed from diffusion regions in a semiconductor substrate of the IC. The diffusion regions may include n-type diffusion or p-type diffusion regions. In at least one example, the diffusion regions are straight or oriented (e.g., by 45 degrees) according to a wafer crystal orientation of the semiconductor substrate to sense normal or shear stress on the surface of the DUT. In at least one example, the stress sensor is integrated with a readout circuit and signal/data processing circuit on a single semiconductor substrate within the IC, which reduces the overall size of the IC. The semiconductor substrate can also have a reduced thickness (e.g., 50 micrometers (μm), 25 μm, or less) to reduce the impact of the stress sensor IC on the expansion or compression of the DUT under the stress sensor and improve the accuracy of the stress measurement by the IC.

In at least one example, a stress sensing resistor have a pair of terminals (e.g., head and tail terminals) across one or more diffusion regions. The pair of terminals may include metal interconnects. One of the pair of terminals is coupled to a higher electric potential (e.g., a voltage or current source), and the other one of the terminals is coupled to a lower electric potential (e.g., ground), to cause a current to flow across the stress sensing resistor. In some examples, the stress sensing resistor may include multiple discrete diffusion regions forming a serpentine to increase the total resistance, which can improve sensitivity. The stress sensing resistor may include metal connections (e.g., metal-to-silicon wires) coupled between a neighboring pair of the discrete diffusion regions. In at least one example, the stress sensing resistor may include a continuous diffusion region forming a serpentine. Such arrangements can reduce local stiffening that would have been caused by the metal connections. Moreover, the presence of the metal interconnects can lead to a mixture of in-plane current (through the diffusion regions) and out-of-plane current (through the metal interconnects) that flow through the sensing resistor, such that the sensing resistor is no longer a single direction sensing element. Accordingly, the metal interconnects can degrade the accuracy of the sensing resistor in sensing stress in a particular direction, and thus removing the metal interconnects can improve the accuracy of stress sensing. Moreover, metal-to-silicon wires cause mismatch in the coefficient of thermal expansion, which in turn results in temperature variation in stress and thus inaccurate reading of the stress. By eliminating or reducing metal connections (e.g., metal-to-silicon wires) between diffusion regions, temperature sensitivity of the stress sensing resistor can be reduced, and the sensor can also become mechanically softer, all of which can further improve the accuracy of stress sensing. In at least one example, the pair of terminals are also made of diffusion or mostly diffusion with little metal connection to further increase sensor's accuracy.

Moreover, reducing the metal interconnects can also reduce the footprint of the stress sensing resistor (and the footprint of the stress sensor). This is because layout design rule check (DRC) of a process technology may require a longer separation distance between the metal interconnect and the diffusion regions than between diffusion regions. Accordingly, by removing the metal interconnects between the diffusion regions, the diffusion regions can be more tightly packed together. Diffusion regions can be fabricated as tighter serpentines because the DRC distance requirement is reduced, and the overall size/footprint of the sensor can be reduced. By reducing the size of the sensor, multiple sensor elements (e.g., diffusion resistors) can be packed in the same area increasing sensor density and hence efficiency.

In at least one example, an integrated stress sensor includes multiple stress sensing resistors having a rotational symmetry that reduce the sensor's sensitivity to alignment errors of the stress sensing resistors with respect to other elements of the semiconductor substrate and the DUT. In at least one example, the integrated stress sensor includes a shear stress sensor and a normal stress sensor. The shear stress sensor includes first diffusion regions in the semiconductor substrate in which the first diffusion regions are symmetrical over a first axis and a second axis, where the first and second axes are orthogonal to each other. The normal stress sensor includes a second diffusion region in the semiconductor substrate that is angled from the first diffusion regions. In at least one example, each of the first diffusion regions is configured to allow a current to flow along a first direction, while each of the second diffusion region is configured to allow a current to flow along a second direction. In at least one example, the first and second directions are angled at 45 degrees from each other. In at least one example, sensor directionality is increased by increasing length (L) to width (W) ratio of single sensing element (e.g., L/W=10/1 or higher).

In at least one example, the integrated circuit stress sensor has a square semiconductor die including the semiconductor substrate to equalize stress sensitivity to different stress directions and types. Crystal orientation to wafer notch orientation impacts sensor sensitivity. In at least one example, sensor sensitivity increases by matching crystal orientation of diffusion type to wafer notch orientation. In at least one example, the first direction is aligned with a first crystal direction (e.g., [110]-crystal direction) of the semiconductor substrate, and the second direction is aligned with a second crystal direction (e.g., [100]-crystal direction) of the semiconductor substrate. In at least one example, the first and second diffusion regions have dopants of opposite polarities. For instance, the first diffusion regions are n-type while the second diffusion regions are p-type. In at least one example, to measure or sense shear stress on a twisted shaft, an n-type sensor is aligned parallel to [100]-crystal direction whereas wafer notch is towards and along shaft axis.

Some applications use insensitive stress sensors to, for example, provide a reference. Diffusion based resistor or interconnect can be laid out such that it becomes insensitive to other stress types and stress directions. In at least one example, n-type and p-type diffusion resistors are combined to reduce the overall stress sensitivity of the combination of resistors.

Here, the same reference numbers or other reference designators are used in the drawings to designate the same or similar (either by function and/or structure) features.

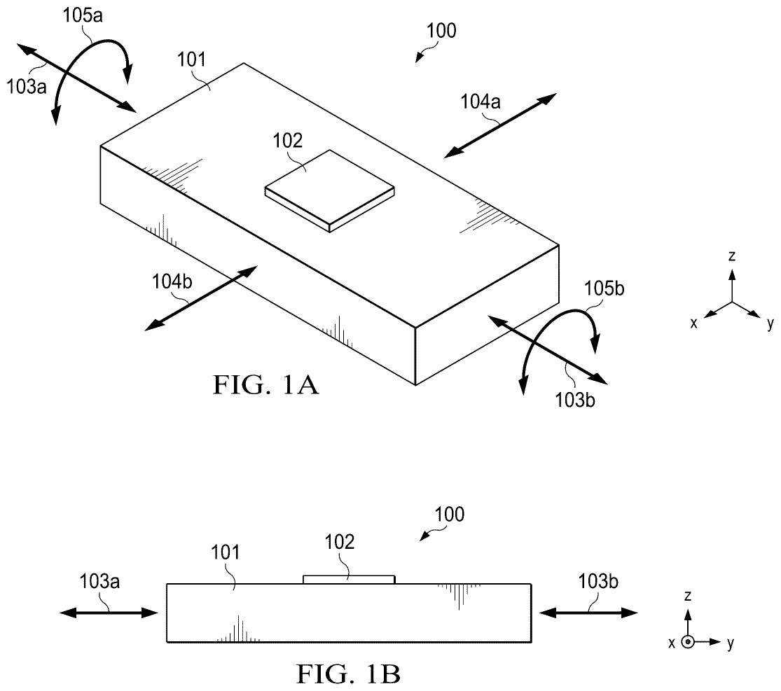

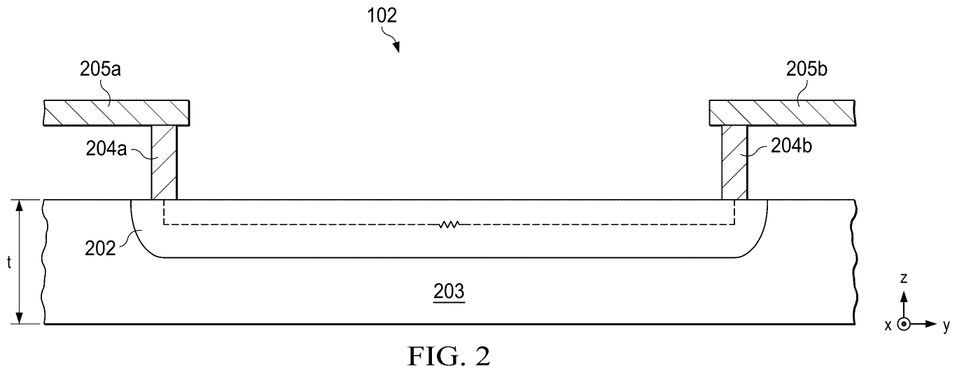

FIG. 1A is a schematic illustrating a perspective view of an apparatus 100 having a stress sensor on a device under test (DUT), in accordance with at least one example. FIG. 1B is a schematic illustrating a side view of the apparatus of FIG. 1A, in accordance with at least one example. DUT 101 can be any component such as a shaft, a packaged integrated circuit (IC), or a component of a machine (e.g., farm equipment, airplane, power tools, etc.). Stress sensor 102 is attached to the surface of DUT 101 by a bonding material, such as an adhesive. As discussed herein, stress sensor 102 can be a piezoresistive sensor comprising diffusion regions in a semiconductor substrate. Stress sensor 102 can have a reduced thickness (e.g., 50 μm, 25 μm, or less), which allows stress sensor 102 to exert minimal mechanical influence on DUT 101, which allows DUT 101 to expand and contract freely without interference from stress sensor 102. In at least one example, stress sensor 102 is an integrated IC which includes a semiconductor substrate having first and second diffusion regions, and a readout circuitry coupled to the first and second diffusion regions. In at least one example, the semiconductor substrate is coupled to or attached to a surface of DUT 101. The readout circuitry is configured to provide signals representing respective resistances of the first and second diffusion regions.

In at least one example, the first diffusions regions are configured to conduct a current along a first direction along a surface of the semiconductor substrate. In at least one example, the second diffusion regions are configured to conduct a current along a second direction along the surface. In at least one example, the first and second directions are angled from each other, and at least one of the first or second diffusion regions are symmetrical over a first axis and a second axis, the first axis and the second axis being orthogonal to each other. Stress (compressive, tensile, or shear) on the surface of DUT 101 is experienced by the semiconductor substrate of stress sensor 102. The stress on the semiconductor substrate is then detected or measured by resistances formed in the first and second diffusion regions. Examples of in-plane stress are indicated by double-sided arrows 103a, 103b, 104a, and 104b while shear stress is indicated by double-sided arrows 105a and 105b. Shear stress is a type of stress that acts parallel to a surface, causing parts of DUT 101 to slide past each other in opposite directions. Normal stress, on the other hand, is stress that acts perpendicular to the surface of DUT 101. For instance, normal stress indicated by double-sided arrows 103a, 103b, 104a, and 104b is perpendicular to the surface of DUT 101 while shear stress indicated by double-sided arrows 105a and 105b arises from a shear force which is parallel to the cross-section of DUT 101. In at least one example, the first diffusion regions are configured to measure out-of-plane stress with respect to the surface. In at least one example, the second diffusion regions are to configured measure in-plane stress with respect to the surface.

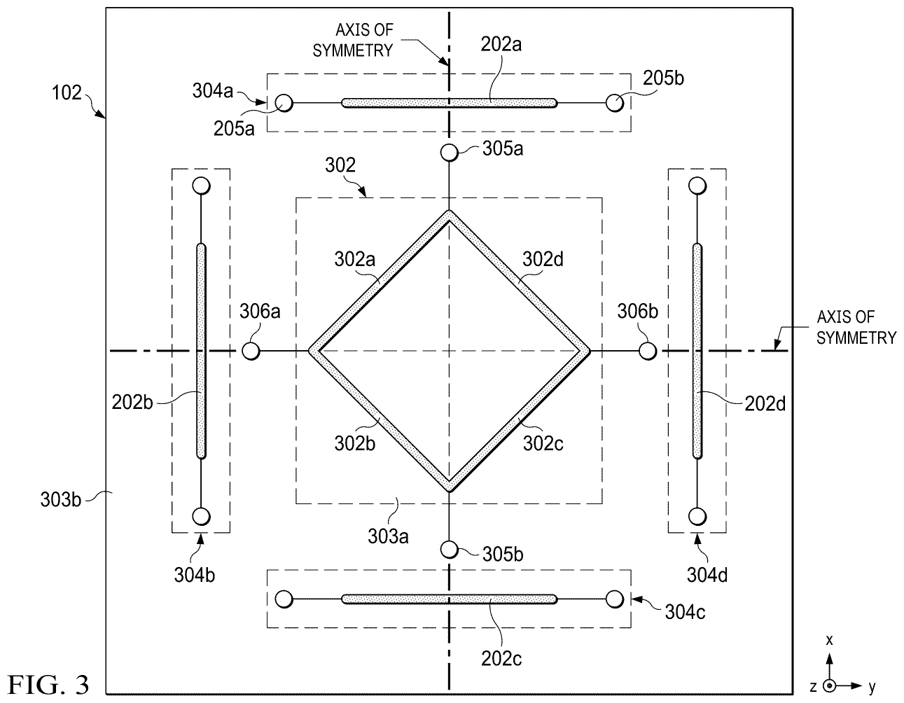

FIG. 2 is a schematic illustrating a cross-section of stress sensor 102 having a semiconductor diffusion region, in accordance with at least one example. The cross-section illustrates diffusion region 202 in semiconductor substrate 203. Diffusion region 202 may be a n-type diffusion region or a p-type diffusion region. Stress sensor 102 also includes metal interconnects 204a, 204b, 205a, and 205b on semiconductor substrate 203 as well as other active circuits (e.g., readout circuitry) that are not shown in FIG. 2, all of which collectively form a semiconductor die. Current flows through metal interconnects 204a, 205a through diffusion region 202 and metal interconnects 204b and 205b. Resistance of diffusion region 202 changes based on stress sensed by a readout circuit on semiconductor substrate 203, which is coupled or attached to DUT 101. The change in resistance of diffusion region 202 is detected by current flow through diffusion region 202.

The thickness (labelled t in FIG. 2) of semiconductor substrate 203 can be at a minimum allowed by the processing technology used to fabricate the semiconductor substrate while maintaining mechanical stability. In some examples, the thickness of semiconductor substrate 203 can be at 10-15 micrometers (um). The reduced substrate thickness can reduce the mechanical influence of the sensor on the compression/expansion of the DUT, which can introduce hysteresis in the sensing output. The overall thickness of stress sensor 102, including the thickness of metal interconnects (e.g., metal interconnects 204a, 204b, 205a, 205b) on semiconductor substrate 203 (which can be at 10 μm or more), can be at 20-25 μm. Some other examples of stress sensor 102 can have a thickness of 50 μm or higher.

Also, current through metal interconnects 204a, 204b have different directions than current through metal interconnects 205a, 205b, where current through metal interconnects 205a, 205b are parallel and of same direction as current through diffusion region 202. Current through metal interconnects 204a, 204b is a vertical current (or an out-of-plane current, e.g., along the z axis) compared to a horizontal current through diffusion region 202 (e.g., or an in-plane current parallel with the x/y axes). This vertical current can cause inaccuracies in resistance measurement of diffusion region 202 near intersection of metal interconnects 204a, 204b and diffusion region 202, because the metal interconnects 204a, 204b have different resistances from diffusion region 202 and do not have the same sensitivity to stress along a particular direction as diffusion region 202. Moreover, metal interconnects can introduce an out-of-plane current which, combines with the in-plane current that flows through diffusion region 202, create a mixture of current directions in the diffusion region 202. Because of this, diffusion region 202 is no longer a single direction sensing element to measure stress in a particular direction, and the change of resistance measured from diffusion region 202 may not accurately reflect stress in a particular direction. In at least one example, kelvin connections made from diffusion interconnects are used to tap diffusion region 202 away from metal interconnects 204a, 204b to accurately capture resistance of diffusion region 202. The kelvin connections have high resistance and do not change current flow direction and can provide voltage measurements along the current path of diffusion region 202. In at least one example, the voltages provided by the kelvin connections can be sensed by a comparator or readout circuitry. The output of the comparator or readout circuitry indicates the change in resistance due to stress on DUT 101.

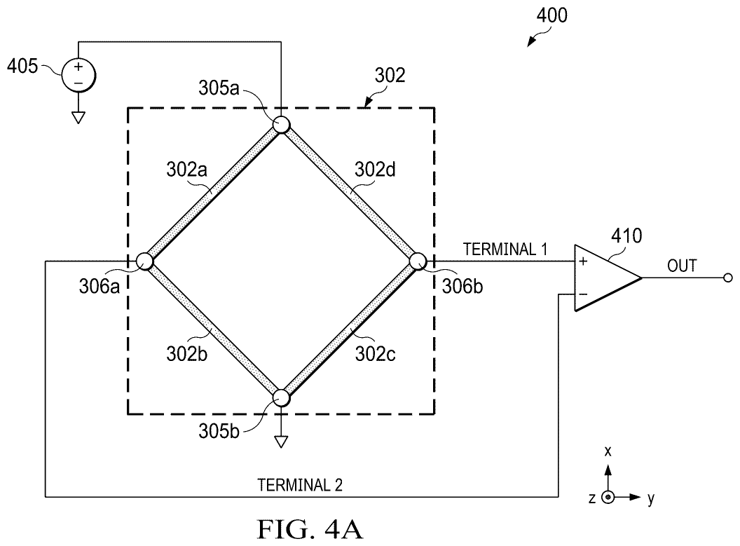

FIG. 3 is a schematic illustrating a top view of stress sensor 102 comprising a shear stress sensor 302 and a set of normal stress sensors 304a, 304b, 304c, and 304d each including, respectively, diffusion regions 202a, 202b, 202c, and 202d, in accordance with at least one example. In at least one example, shear stress sensor 302 is configured to have diffusion regions 302a, 302b, 302c, and 302d which are at +/−45 degrees relative to the diffusion regions 202a-d of the set of normal stress sensors 304a, 304b, 304c, and 304d. In at least one example, shear stress sensor 302 is configured as a full Wheatstone bridge. In other examples, a half bridge configuration may be used for shear stress sensor 302. Metal interconnects 305a and 305b can be used as current terminals while metal interconnects 306a, 306b are used as sense terminals to connect to a readout circuitry. In at least one example, shear stress sensor 302 is formed in first region 303a of semiconductor substrate 203 while the set of set of normal stress sensors 304a, 304b, 304c, and 304d are formed in a second region 303b of semiconductor substrate 203. In at least one example, diffusion regions 302a-d are of one conductivity type, and diffusion regions 202a-d are of a different (and opposite) conductivity type. For instance, in some examples, diffusion regions 202a-d can be of p-type, and diffusion regions 302a-d can be of n-type. In some examples, diffusion regions 202a-d can be of n-type, and diffusion regions 302a-d can be of p-type. As to be described below, the conductivity type and orientation of the diffusion region, for detecting a particular type of stress (e.g., shear stress versus normal stress), can be based on the crystal orientation of the wafer from which the semiconductor substrate 203 is fabricated. In some examples, diffusion regions 302a-d and diffusion regions 202a-d can also have the same conductivity type.

In at least one example, first region 303a is partitioned into four quadrants that are symmetrical over a first axis (e.g., x-axis) and a second axis (e.g., y-axis), where the first and second axes are orthogonal to each other. First region 303a can also be a center (laterally, e.g., along the x and y axes) of the semiconductor die of stress sensor 102 comprising semiconductor substrate 203 and the metal interconnects. The orientation of diffusion region 302a is a mirror image of the orientation of diffusion region 302d, and the orientation of diffusion region 302b is a mirror image of the orientation of diffusion region 302c, and likewise the orientation of diffusion region 302a is a mirror image of the orientation of diffusion region 302b, and the orientation of diffusion region 302c is a mirror image of the orientation of diffusion region 302d. The symmetry of diffusion regions 302a-d, as well as having diffusion regions 302a-d at a center of the die of stress sensor 102, can reduce/eliminate the sensitivity of stress sensor 102 to alignment errors of diffusion regions 302a-d with respect to other elements of semiconductor substrate 203 and with respect to the DUT. In at least one example, each of the diffusion regions 302a, 302b, 302c, and 302d of first diffusion region 303a is configured to allow a current to flow along a first direction, while each of the second diffusion regions 303b is configured to allow a current to flow along a second direction, where the first and second directions are angled at +/−45 degrees from each other.

In at least one example, shear stress sensor 302 is placed in the center of the die to equalize stress sensitivity to different stress directions and types. In at least one example, the set of normal stress sensors 304a, 304b, 304c, and 304d are on a periphery of shear stress sensor 302. For example, normal stress sensors are formed on the four sides of shear stress sensor 302. The location of shear stress sensor 302 relative to the set of normal stress sensors 304a, 304b, 304c, and 304d can be based on crystal orientation of the wafer from which semiconductor substrate 203 of stress sensor 102 is fabricated. Crystal orientation to wafer notch orientation impacts sensor sensitivity. Sensor sensitivity increases by matching diffusion type and resistor/diffusion region orientation to crystal orientation to wafer notch orientation, while stress sensor 102 (and the diffusion regions) are oriented with respect to the DUT to maximize the sensitivity of normal stress sensors 304a-d to normal stress and to maximize the sensitivity of shear stress sensor 302 to shear stress. In at least one example, the first direction is aligned with a first crystal direction (e.g., [110]-crystal direction) of the semiconductor substrate, and the second direction is aligned with a second crystal direction (e.g., [100]-crystal direction) of the semiconductor substrate.

In at least one example, diffusion regions 302a-d and diffusion regions 202a-d have dopants of opposite polarities. For instance, diffusion regions 302a-d can be of n-type while diffusion regions 202a-d can be of p-type. In one example, to measure or sense shear stress on a twisted shaft, n-type diffusion region of the stress sensor is aligned parallel to [100]-crystal direction whereas wafer notch is towards [100] and along shaft axis. In at least one example, with a different crystal orientation of wafer notch, sensor 302 can be configured as a normal stress sensor while sensors 304a, 304b, 304c, and 304d can be configured as shear stress sensors.

The set of normal stress sensors 304a, 304b, 304c, and 304d detect or measure stress in the x and y directions. Each normal stress sensor includes a diffusion region which is in the x or y direction and is coupled to first and second terminals 205a and 205b, respectively. For instance, normal stress sensor 304a includes diffusion region 202a along the x-direction and is coupled to first and second terminals 205a and 205b, respectively, where first and second terminals 205a and 205b comprise metal interconnects. Shear stress sensor 302 detects or measures stress at +/−45 degrees relative to x and y directions.

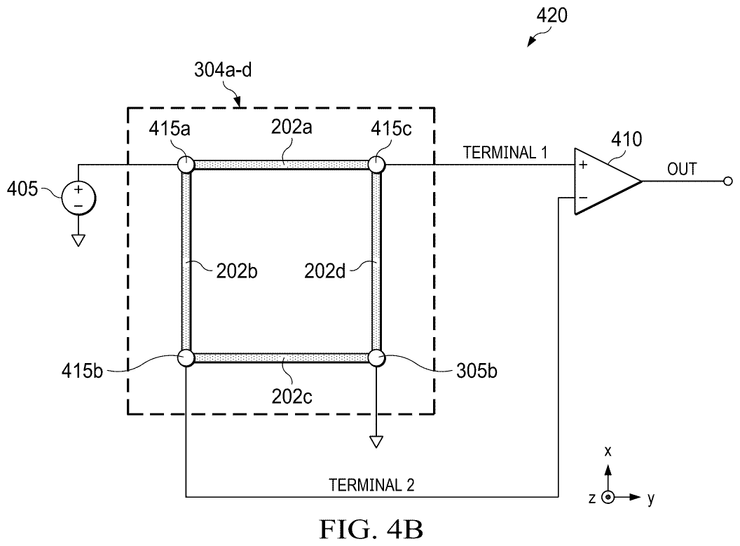

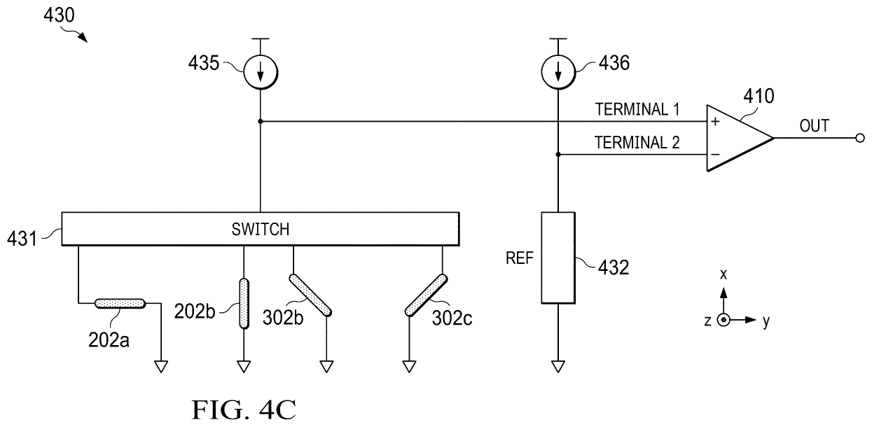

FIGS. 4A-B are schematics illustrating read-out circuitries 400 and 420, respectively, for diffusion regions configured as resistor bridges, in accordance with at least some examples. Read-out circuitry 400 comprises a comparator 410 having a first terminal (terminal1) coupled to metal interconnect 306a and a second terminal (terminal2) coupled to metal interconnect 306b of shear stress sensor 302. Metal interconnects/terminals 305a and 305b are current terminals coupled to a source 405 and a ground, respectively. The output “out” of comparator 410 indicates the relative difference between voltages on terminal1 and terminal2. In this example, shear stress sensor 302 is configured as a bridge (e.g., Wheatstone bridge) with diffusion regions 302a, 302b, 302c, and 302d which are at 45 degrees relative to, e.g., x and y axes (and/or diffusion regions 202a-d). Source 405 provides a current that flows through diffusion regions 302a and 302b and generate a first voltage at terminal 306a. Voltage source 405 also provides a current that flows through diffusion regions 302d and 302c and generates a second voltage at terminal 306b. Shear stress can change the resistances of diffusion regions 302a-d and introduce a voltage offset between terminals 306a and 306b, which can be sensed by comparator 410.

Read-out circuitry 420 is like read-out circuitry 400 in function. Here, normal sensors 304a-d are configured as a bridge with diffusion regions 202a, 202b, 202c, and 202d which are at parallel or orthogonal to the x and y axes (and 45 degrees from diffusion regions 302a-d). Diffusion regions 202a and 202b are coupled together at a terminal 415a (which can include terminal 205b), which is coupled to source 405. Diffusion regions 202b and 202c are coupled together at a terminal 415b, which is coupled to the second terminal of comparator 410. Diffusion regions 202a and 202d are coupled together at a terminal 415c (which can include terminal 205a), which is coupled to the first terminal of comparator 410. Diffusion regions 202c and 202d are coupled together at a terminal 415d, which is coupled to ground.

FIG. 4C is a schematic illustrating a read-out circuitry 430, in accordance with at least one example. Read-out circuitry 430 comprises analog switch 431, reference diffusion resistor (REF) 432, current sources 435 and 436, and a variety of resistors comprising diffusion regions 202a, 202b (of normal stress sensors 304a, 304b), 302b, and 302c (of shear stress sensor 302). In at least one example, analog switch 431 comprises pass-gates controllable by controls (not shown) that selectively couples a diffusion resistor (e.g., one of diffusion regions 202a, 202b, 302b, and 302c) terminal1. In at least one example, comparator 410 provides an output representing a difference of voltages between terminal1 and terminal2, which can provide a measurement of a stress on the selected diffusion resistor that causes a change in the resistance of the selected diffusion resistor, as compared to REF 432. In some examples, read-out circuitry 430 may also include multiple reference resistors coupled to the terminal 2 via a switch device (not shown in FIG. 4C), and a different reference resistor can be selected to be compared against each of diffusion regions 202a, 202b, 302b, and 302c.

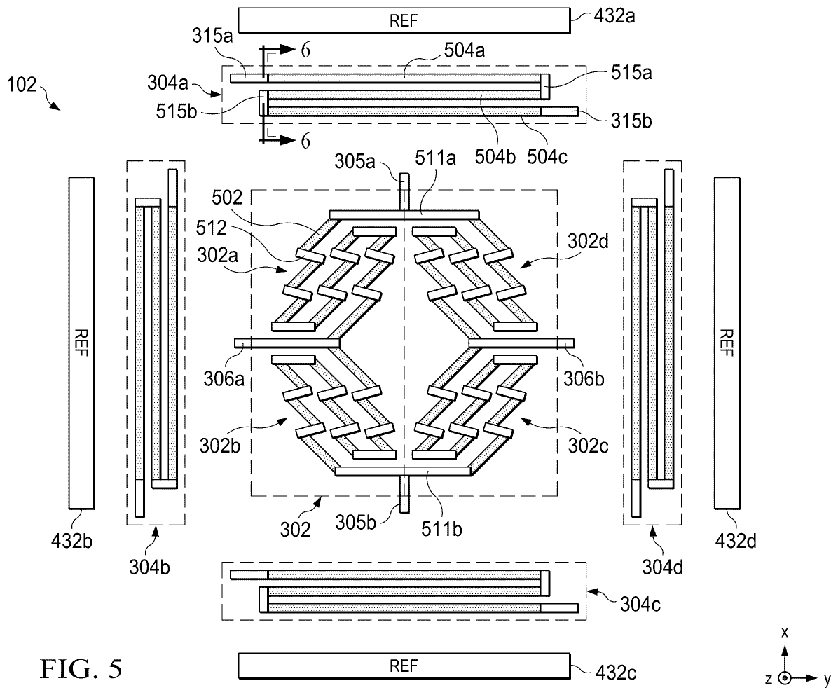

FIG. 5 is a schematic illustrating stress sensor 102 with shear stress sensor and a set of normal stress sensors having a combination of metal and diffusion components, in accordance with at least one example. In at least one example, shear stress sensor 302 includes regions 302a, 302b, 302c, and 302d each including a serpentine resistor. Each serpentine resistor includes multiple diffusion regions. For instance, region 302a has three rows of serpentine diffusion segments 502 that are at +/−45 degrees relative to the y-axis. In this example, diffusion segments 502 are stringed together over three rows via metal segments 512 to form a serpentine resistor. Likewise, other regions 302b, 302c, and 302d include diffusion segments that are symmetrical to those in region 302a. In other examples, fewer or more than three rows of diffusion segments 502 can be stringed to form a resistor. In at least one example, the first and last diffusion segments from the rows of diffusion segments 502 are connected to metal interconnects. For instance, first diffusion segment in region 302a is connected to metal interconnect 511a which extends along the x-axis. In at least one example, metal interconnect 511a couples to current terminals 305a which extends in the y-direction. Metal interconnect 511a also connects to the first diffusion segment in region 302d. Likewise, first diffusion segment in diffusion region 302b is connected to metal interconnect 511b which extends along the x-axis. In at least one example, metal interconnect 511b couples to current terminals 305b which extends in the y-direction. Metal interconnect 511b also connects to the first diffusion segment in diffusion region 302c. Metal interconnect 306a connects to last diffusion segments of diffusion regions 302a and 302b, where metal interconnect 306a forms a first sense terminal which couples to terminal1 of comparator 410. Metal interconnect 306b connects to last diffusion segments of diffusion regions 302d and 302c, where metal interconnect 306b forms a second sense terminal which couples to terminal2 of comparator 410.

In at least one example, normal stress sensors 304a, 304b, 304c, and 304d also include serpentine resistors including multiple diffusion segments that are coupled with one another via metal interconnects. These diffusion segments either extend in the x-direction or the y-direction and are 45 degrees angled from the diffusion segments of shear stress sensor 302. For instance, normal stress sensor 304a includes diffusion segments 504a, 504b, and 504c coupled to one another via metal interconnects 515a and 515b which extend orthogonal to diffusion segments 504a, 504b, and 504c. Normal stress sensor 304a has a first terminal and a second terminal coupled to metal interconnects 315a and 315b, respectively. In at least one example, a current source and a ground terminal are coupled to metal interconnects 315a and 315b, respectively. In at least one example, normal stress sensor 304a is tapped at two points along the diffusion segments and these taps are coupled to comparator 410. In at least one example, normal stress sensor 304a is tapped at one point and coupled to a first terminal of comparator 410 while a reference resistor 432a, which can include diffusion regions, is coupled to a second terminal of comparator 410.

The minimum separation between the rows of diffusion segments, and between a diffusion segment and a metal interconnect, can be set by various factors, such as layout design rule check (DRC) of a process technology. In this example, DRC may require a certain minimum separation between metal interconnects 512 and diffusion segments 502, which imposes limit on how small the overall footprint of the stress and shear sensors can be. As to be discussed below, metal interconnects 512 can be replaced with diffusion segments to relax DRC minimum distance allowing to place more rows of diffusion segments for the same area, and to reduce the impact of the metal interconnects on the accuracy of the stress sensor.

In at least one example, each normal stress sensor has a corresponding reference diffusion resistor. For instance, normal stress sensor 304b has a corresponding reference diffusion resistor 432b which has diffusion regions extending in the same direction as the diffusion segments of normal stress sensor 304b. Likewise, normal stress sensor 304c has a corresponding reference diffusion resistor 432c which has diffusion regions extending in the same direction as the diffusion segments of normal stress sensor 304c. Normal stress sensor 304d has a corresponding reference diffusion resistor 432d which has diffusion regions extending in the same direction as the diffusion segments of normal stress sensor 304d.

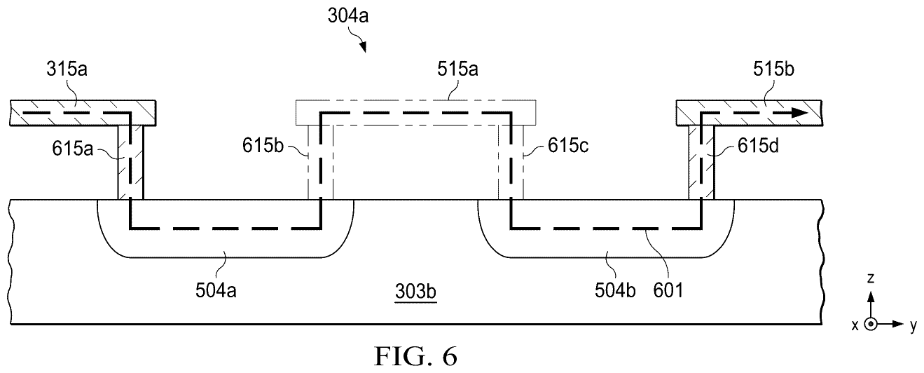

FIG. 6 is a schematic illustrating a portion of a cross-section of the stress sensor of FIG. 5, in accordance with at least one example. Here, a portion of normal stress sensor 304a is illustrated where metal interconnect 315a (e.g., current source terminal) is coupled to one end of diffusion segment 504a through via or metal interconnect 615a. The other end of diffusion segment 504a is coupled to metal interconnect 515a through via or metal interconnect 615b and continues to connect to one end of next diffusion segment 504b through via or metal interconnect 615c. The other end of segment 504b is coupled to metal interconnect 515b through via or metal interconnect 615d and continues to connect to the next diffusion segment 504c through a via or metal interconnect. Current flow is indicated by identifier 601 and this current flow changes direction from horizontal (or in-plane, relative to a major surface of semiconductor substrate 203) to vertical (or out-of-plane, relative to the major surface of semiconductor substrate 203) as it passes through metal interconnect 315a and 615a towards diffusion segments. The vertical direction of current is orthogonal to the horizontal direction of current in the diffusion segments 504a and 504b. The out-of-plane current in diffusion segments 504a and 504b near the interface with metal interconnects 615a, 615b, 615c, and 615d can introduce inaccuracies when measuring stress using the horizontal/in-plane currents through diffusion segments 504a and 504b, at least because the in-plane and out-of-plane current path resistance experience different stresses. As discussed herein. in at least one example, kelvin connections are provided that tap one or more diffusion segments to sense current-free voltage and to mitigate the impact of vertical current that may cause inaccuracies in sensing stress as current through the diffusion segments is horizontal.

In addition, in some examples, having metal interconnects directly over diffusion regions can introduce residual stress in the diffusion region, which can further degrade the accuracy of stress sensing using the diffusion regions. Specifically, during the deposition of metal interconnects over the diffusion region, substantial heat is imparted on the diffusion region, which experiences thermal expansion. After the deposition, both the metal interconnects and the semiconductor substrate can contract as the heat is dissipated, but due to thermal coefficient mismatch between the metal interconnects and the semiconductor substrate, the metal interconnects and the semiconductor substrate can experience different degrees of contraction, which introduces inherent/residual stress in the diffusion region. Such inherent/residual stress can add to the stress that is being measured by the diffusion region and introduce inaccuracy in the sensor output.

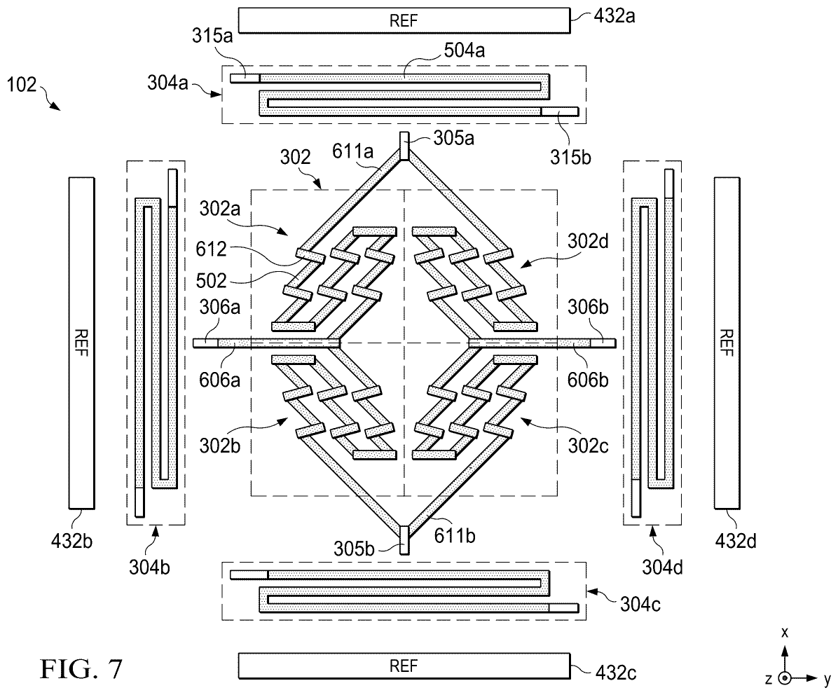

FIG. 7 is a schematic illustrating an example of stress sensor 102 with shear stress sensor and a set of normal stress sensors having mainly diffusion components, in accordance with at least one example. To reduce the impact of out-of-plane current as well as residual stress, at least some of the metal interconnects in FIGS. 5 and 6 are replaced with diffusion regions so that the shear and normal stress sensors include continuous and serpentinous diffusion regions, in accordance with at least one example.

Specifically, referring to FIG. 7, metal interconnect 511a and 511b of FIG. 6 are replaced with diffusion segments 611a of diffusion regions 302a and 302d to connect to metal interconnect 305a. Likewise, metal interconnect 511a and 511b of FIG. 6 are replaced with diffusion segments 611b of diffusion regions 302b and 302c to connect to metal interconnect 305b. In at least one example, metal interconnects 306a and 306b are also reduced by replacing sections of the metal interconnects with diffusion segments 606a and 606b that connect to diffusion regions 302a, 302b, 302c, and 302d. In at least one example, the metal interconnects 512 between diffusion segments 502 are also replaced with diffusion segments 612. With such arrangements, the diffusion regions of shear stress sensor 302 that are angled (e.g., 45 degrees) from the normal stress sensor 304 and used for shear stress sensing, such as diffusion segments 502, may have no metal interconnects above them, which can reduce out-of-plane current and residual stress and improve the accuracy of the sensor output.

Removing the metal interconnects between diffusion segments and forming a continuous serpentinous diffusion region can provide additional advantages. Specifically, the metal interconnects can introduce local stiffening on the mechanically softer semiconductor substrate of the stress sensor, which can impact the sensor accuracy. Removing the metal interconnects can reduce/eliminate such local stiffening. Also, DRC may require a larger separation distance between diffusion region and metal interconnects than between diffusion regions. Accordingly, having a continuous serpentinous diffusion region means the diffusion segments can be packed together more tightly, which allows the footprint of the sensor IC to be reduced and/or allows packing more sensor elements per area and increasing the sensor density. The influence of resistor head resistance can also be reduced. All these can improve the performance of the stress sensor.

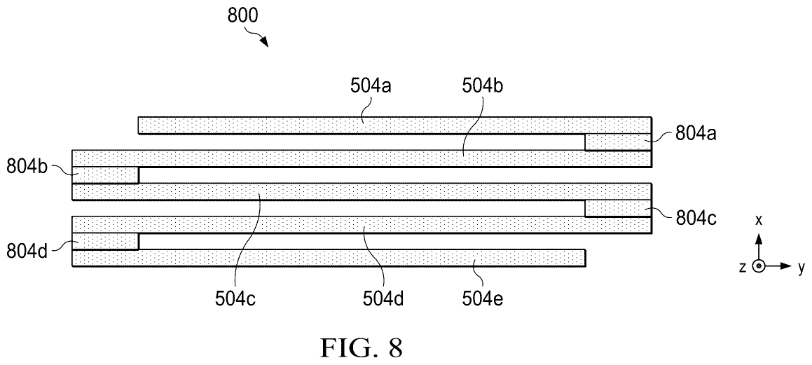

FIG. 8 is a schematic illustrating a diffusion region 800, in accordance with at least one example. Diffusion region 800 can be of n-type or p-type. As shown in FIG. 8, diffusion region 800 has wide diffusion interconnect regions 804a, 804b, 804c, and 804d connecting straight diffusion regions 504a, 504b, 504c, 504d, and 504e. The wide diffusion interconnect regions 804a, 804b, 804c, and 804d (along an axis perpendicular to the flow of current, such as the y-axis in FIG. 8) allow for low resistivity and ease in current flow around the corners of the straight diffusion regions 504a-e and to reduce the impact of the corners in sensing stress, which is sensed by measuring change in resistance of diffusion resistor 800. Wider diffusion interconnect regions 804a, 804b, 804c, and 804d facilitate current flow along minor portions of diffusion resistor 800 (e.g., regions 804a-d that are parallel with the y-axis in FIG. 8) and reduce the resistance of diffusion resistor 800 along such direction, so that the resistance of diffusion resistor 800 is dominated by the current path along the major portion of the diffusion resistor 800 (e.g., straight diffusion regions 504a-e that are parallel with the x-axis in FIG. 8). Since the change of resistance of the straight diffusion regions 504a-e is to be sensed to measure stress, such arrangements can improve the accuracy of sensor output.

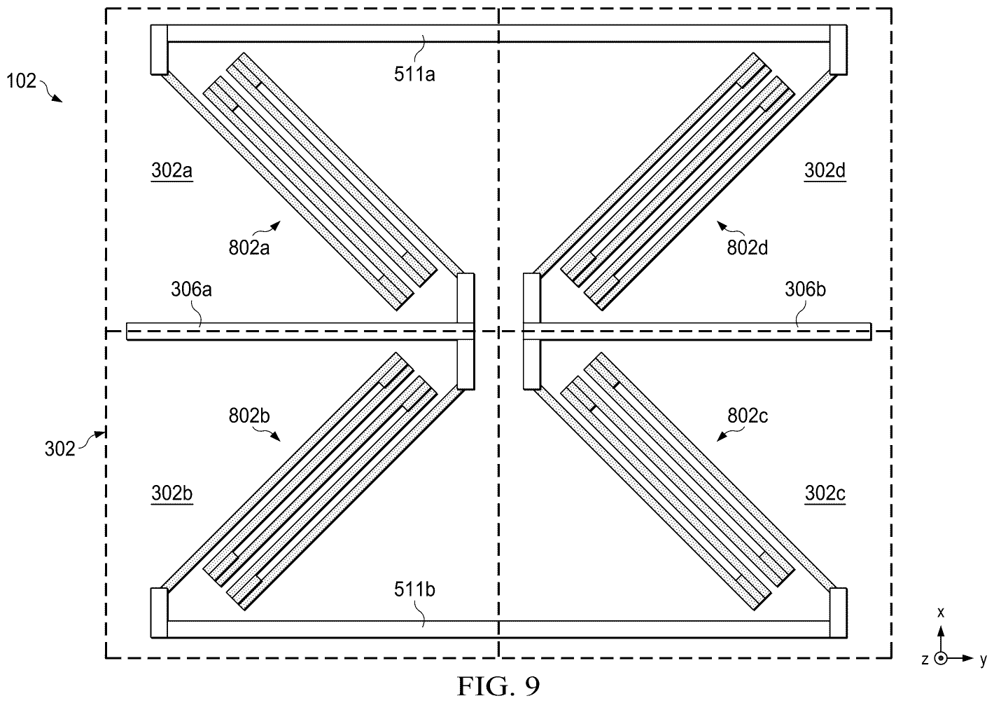

In at least on example, diffusion resistor 800 can be used as part of normal stress sensors 304a-d. In at least one example, diffusion resistor 800 can be used as part of shear stress sensor 302. FIG. 9 illustrates an example of stress sensor 102 where diffusion resistor 802a is in region 302a, diffusion resistor 802b is in region 302b, diffusion resistor 802c is in region 302c, and diffusion resistor 802d is in region 302d. Interconnects 511a, 511b, 306a, and 306b can be metal or diffusion regions. Compared with the arrangement of FIG. 7, the arrangement of FIG. 9 can be more compact while increasing/maximizing the current path (and the resistance) along a single direction in each quadrant, which can improve the sensitivity of the shear stress sensor.

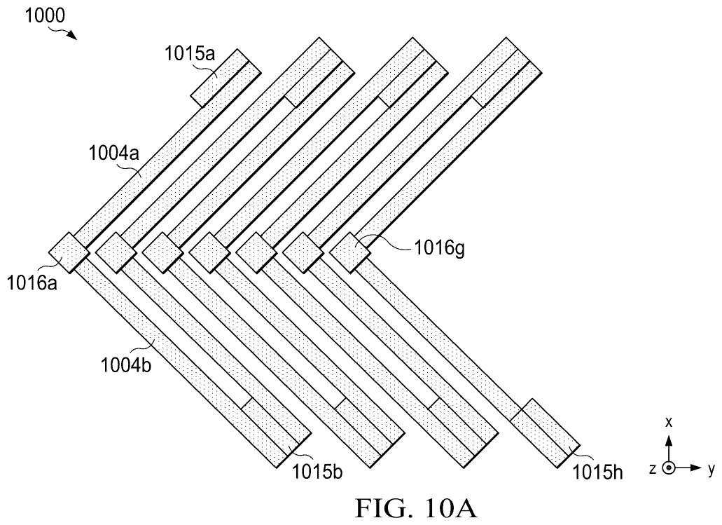

FIG. 10A is a schematic illustrating a diffusion resistor 1000 with angled wider diffusion interconnect regions connecting angled straight diffusion regions, in accordance with at least one example. Diffusion resistor 1000 can provide a reference for comparing with the resistances of the diffusion regions of shear stress sensor 302. Here, the straight long portions of diffusion segments 1004a and 1004b are angled at +/−45 degrees with reference to x and y axes. Diffusion segments 1004a and 1004b have the same length, and together forming a symmetrical L-shaped structure. Diffusion interconnect regions 1015a, 1015b, and 1015h and diffusion interconnect regions 1016a, 1016b, and 1016g provide low resistivity at the corners of the ends of straight long portions of diffusion segments 1004a and 1004b. Low resistivity is achieved by making diffusion interconnect regions 1015a, 1015b, and 1015h and diffusion interconnect regions 1016a, 1016b, and 1016g wide (e.g., perpendicular to the direction of current flow).

Diffusion resistor 1000, having symmetrical L-shapes, can be used as a reference sensor that has reduced sensitivity to stress. FIG. 10B illustrates how the symmetrical L-shape leads to reduced sensitivity. Specifically, in FIG. 10B, stress sensor 1000 has a diffusion region that extends in length along the y-axis and detects stress in the y-direction and may not detect stress in the x-axis. When the stress is in the y direction (represented by σ_{yy} in FIG. 10B), half of the resistors detect the stress. For instance, the first diffusion resistor (R₁ in FIG. 10B) detects the stress while the second diffusion resistor (R₂ in FIG. 10B) may not detect the stress. When the stress is in the x direction (represented by σₓₓ in FIG. 10B), again half of the resistors detect the stress. For instance, the second diffusion resistor detects stress while the first diffusion resistor may not detect the stress. As such, the L-shaped structure of diffusion regions on average is insensitive to stress in the x an and y directions. The L-shaped structure of sensor 1020 enables symmetry with respect to normal stress direction. For instance, independent of normal stress direction, there is always the same amount of longitudinal and perpendicular resistance oriented to the stress.

In at least one example, sensors comprising p-type diffusion and n-type diffusion are fabricated next to one another and resistance change is measured for both sensors. The different readouts from the sensors with different diffusion types is used to compensate positive with negative stress sensitivity, depending on piezoresistive coefficients.

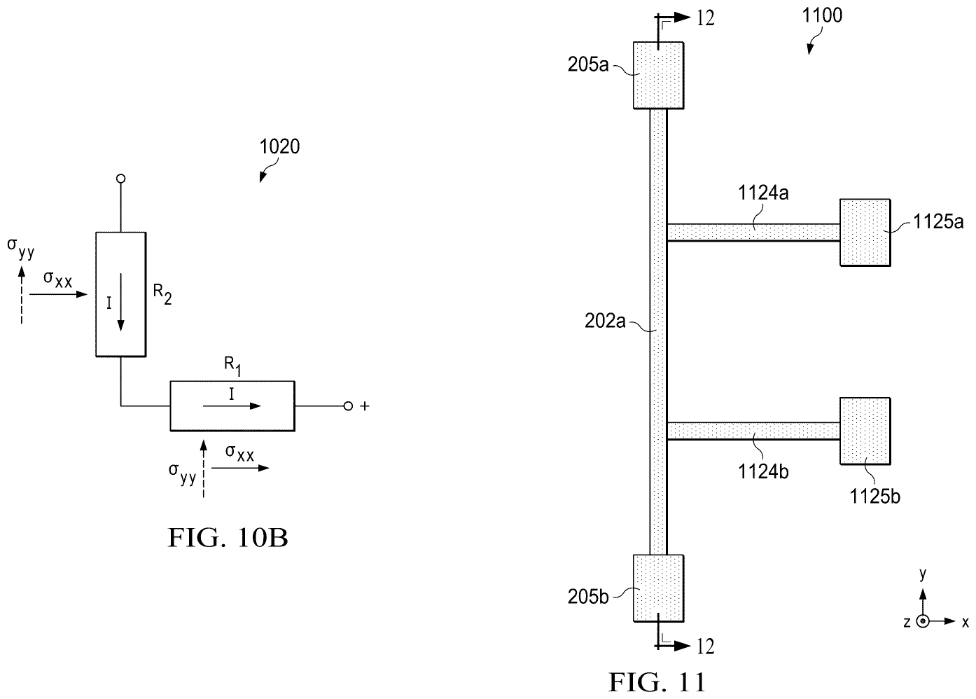

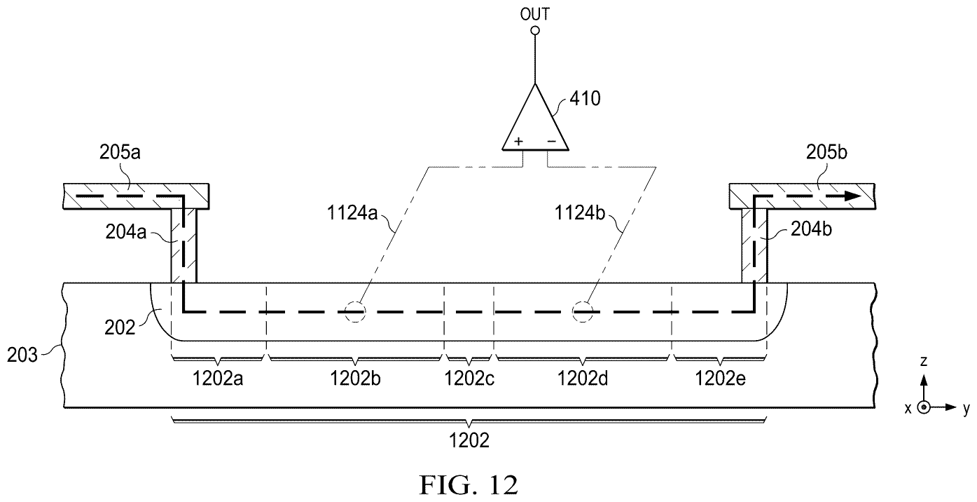

FIG. 11 is a schematic illustrating a top view of a diffusion sensor 1100 with kelvin connections, in accordance with at least one example. FIG. 12 is a schematic illustrating a side view of FIG. 11 with a read-out circuitry coupled to kelvin connections, in accordance with at least one example. In a 2-point measurement of resistance of stress sensor 102 of FIG. 2 through metal interconnects 205a and 205b, the current flows in multiple directions including current along the y-direction (or x-direction) and current along the z-direction (e.g., through metal interconnects 204a and 204b). The current in the x-direction is the out-of-plane current while the current along the resistor orientation is the in-plane current (e.g., along the y-direction). The out-of-plane current introduces inaccuracies in sensing stress because current at or near the intersection of interconnect 204a and diffusion region 202 can be in any direction before the current stabilizes.

In the example of diffusion sensor 1100, metal interconnects are replaced with diffusion. In at least one example, diffusion segments 1124a and 1124b are tapped to diffusion region 202a near out-of-plane terminals or pads 205a and 205b. Here, out-of-plane terminals or pads 1125a and 1125b are diffusion and out-of-plane to connect to comparator 410. Diffusion region 202 is divided into sections 1202a, 1202b, 1202c, 1202d, and 1202e, collectively referred to as 1202. Sections 1202a and 1202e are near the vicinity of out-of-plane interconnects 204a and 204b and these sections may have currents in different directions. Sections 1202b, 1202c, and 1202d have current along the direction of diffusion. Change in resistance indicates stress induced on diffusion region 202 and can be detected by measuring voltage near the edges of sections 1202a and 1202b and near edges of sections 1202d and 1202e. In at least one example, diffusion segments 1124a and 1124b are tapped in sections 1202b and 1202d. Voltage measurement can be performed between out-of-plane terminals or pads 1125a and 1125b while driving current through out-of-plane terminals or pads 205a and 205b result in detecting resistance change along an in-plane current path versus an applied stress, which can reduce the effect of out-of-plane current on the stress sensing operation.

The following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.
Example 1 is an apparatus comprising: a semiconductor substrate; a shear stress sensor including first diffusion regions in the semiconductor substrate, in which the first diffusion regions are symmetrical over a first axis and a second axis, the first and second axes being orthogonal to each other; and normal stress sensors including a second diffusion region in the semiconductor substrate.
Example 2 is an apparatus according to any example herein, in particular example 1, wherein each of the first diffusion region is configured to allow a current to flow along a first direction, each of the second diffusion region is configured to allow a current to flow along a second direction, and the first and second directions are angled at 45 degrees from each other.
Example 3 is an apparatus according to any example herein, in particular example 2, wherein the first direction is aligned with a first crystal direction of the semiconductor substrate, and the second direction is aligned with a second crystal direction of the semiconductor substrate.
Example 4 is an apparatus according to any example herein, in particular example 3, wherein the first crystal direction is a [110]-crystal direction, and the second crystal direction is a [100]-crystal direction.
Example 5 is an apparatus according to any example herein, in particular example 1, wherein the first and second diffusion regions have dopants of opposite polarities.
Example 6 is an apparatus according to any example herein, in particular example 1, wherein at least one of the first or second diffusion regions includes a first straight diffusion region, a second straight diffusion region, a third straight diffusion region, and a fourth straight diffusion forming a serpentine resistor.
Example 7 is an apparatus according to any example herein, in particular example 6, further comprising a first metal interconnect coupled between the first and second straight diffusion regions, a second metal interconnect coupled between the second and third straight diffusion regions, and a third metal interconnect coupled between the third and fourth straight diffusion regions, wherein the first, second, and third metal interconnects are over the semiconductor substrate.
Example 8 is an apparatus according to any example herein, in particular example 6, further comprising a first interconnect diffusion region coupled between the first and second straight diffusion regions, a second interconnect diffusion region coupled between the second and third straight diffusion regions, and a third interconnect diffusion region coupled between the third and fourth straight diffusion regions, wherein the first, second, and third interconnect diffusion regions are in the semiconductor substrate.
Example 9 is an apparatus according to any example herein, in particular example 8, wherein each of the first, second, and third interconnect diffusion region has a length and a width larger than a respective width of each of the first, second, and third straight diffusion regions.
Example 10 is an apparatus according to any example herein, in particular example 6, wherein the first and second straight diffusion regions are aligned with different directions, the third and fourth straight diffusion regions are aligned with different directions, the first and second straight diffusion regions have a same length, and the third and fourth straight diffusion regions have a same length.
Example 11 is an apparatus according to any example herein, in particular example 1, wherein the apparatus is free of metal interconnects over a footprint of the first diffusion regions and a footprint of the second diffusion regions.
Example 12 is an apparatus according to any example herein, in particular example 11, further comprising reference resistors on a periphery of the normal stress sensors.
Example 13 is an apparatus according to any example herein, in particular example 12, wherein the normal stress sensors are laterally between the reference resistors and the shear stress sensor.
Example 14 is an apparatus according to any example herein, in particular example 1, wherein the shear stress sensor includes: a first one, a second one, a third one, and a fourth one the first diffusion regions; a first current terminal coupled to a first end of the first one of the first diffusion regions and a first end of the second one of the first diffusion regions; a second current terminal coupled to a first end of the third one of the first diffusion regions and a first end of the fourth one of the first diffusion regions; a first sense terminal coupled to a second end of the first one of the first diffusion regions and a second end of the second one of the first diffusion regions; a second sense terminal coupled to a second end of the third one of the first diffusion regions and a second end of the fourth one of the first diffusion regions; and a readout circuit on a periphery of the normal stress sensors and coupled to the first and second sense terminals.
Example 15 is an apparatus according to any example herein, in particular example 14, wherein the first and second sense terminals include, respectively, third and fourth diffusion regions in the semiconductor substrate, each of the third and fourth diffusion regions having a high resistance than each of the first diffusion regions.
Example 16 is an apparatus according to any example herein, in particular example 14, further comprising a first reference resistor and a second reference resistor, wherein the readout circuit includes a first comparator and a second comparator, the first comparator having a first input coupled to the first sense terminal and a second input coupled to the first reference resistor, and the second comparator having a first input coupled to the second sense terminal and a second input coupled to the second reference resistor.
Example 17 is an apparatus according to any example herein, in particular example 1, wherein the normal stress sensors include: a first one, a second one, a third one, and a fourth one the second diffusion regions on, respectively, a first side, a second side, a third side, and a fourth side of the shear stress sensor; a first current terminal coupled to a first end of the first one of the second diffusion regions and a first end of the second one of the second diffusion regions; a second current terminal coupled to a first end of the third one of the second diffusion regions and a first end of the fourth one of the second diffusion regions; a first sense terminal coupled to a second end of the first one of the second diffusion regions and a second end of the second one of the second diffusion regions; a second sense terminal coupled to a second end of the third one of the second diffusion regions and a second end of the fourth one of the second diffusion regions; and a readout circuit on a periphery of the normal stress sensors and coupled to the first and second sense terminals.
Example 18 is an apparatus according to any example herein, in particular example 1, wherein the normal stress sensors are on four sides of the shear stress sensor.
Example 19 is an apparatus according to any example herein, in particular example 1, wherein a thickness of the substrate is less than 50 μm.
Example 20 is an apparatus according to any example herein, in particular example 1, wherein the shear stress sensor is on a peripheral of the normal stress sensors.
Example 21 is an integrated circuit comprising: a semiconductor substrate having: first and second diffusion regions, the first diffusions region configured to conduct a current along a first direction along a surface of the semiconductor substrate, the second diffusion regions configured to conduct a current along a second direction along the surface, in which the first and second directions are angled from each other, and at least one of the first or second diffusion regions are symmetrical over a first axis and a second axis, the first axis and the second axis are orthogonal to each other; and a readout circuitry coupled to the first and second diffusion regions and configured to provide signals representing respective resistances of the first and second regions.
Example 22 is an apparatus according to any example herein, in particular example 21, wherein the first diffusion regions are configured to measure out-of-plane stress with respect to the surface, and wherein the second diffusion regions are to configured measure in-plane stress with respect to the surface.
Example 23 is an apparatus according to any example herein, in particular example 21, wherein the first direction is aligned with a first crystal direction of the semiconductor substrate, and the second direction is aligned with a second crystal direction of the semiconductor substrate.
Example 24 is an apparatus according to any example herein, in particular example 23, wherein the first crystal direction is a [110]-crystal direction, and the second crystal direction is a [100]-crystal direction.
Example 25 is an apparatus according to any example herein, in particular example 21, wherein the first and second diffusion regions have dopants of opposite polarities.
Example 26 is an apparatus according to any example herein, in particular example 22, wherein the first diffusion regions includes a shear stress sensor which includes: a first one, a second one, a third one, and a fourth one the first diffusion regions; a first current terminal coupled to a first end of the first one of the first diffusion regions and a first end of the second one of the first diffusion regions; a second current terminal coupled to a first end of the third one of the first diffusion regions and a first end of the fourth one of the first diffusion regions; a first sense terminal coupled to a second end of the first one of the first diffusion regions and a second end of the second one of the first diffusion regions; and a second sense terminal coupled to a second end of the third one of the first diffusion regions and a second end of the fourth one of the first diffusion regions, wherein the first and second sense terminals are coupled to the readout circuitry.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a semiconductor substrate;
a shear stress sensor including first diffusion regions in the semiconductor substrate, in which the first diffusion regions are symmetrical over a first axis and a second axis, the first and second axes being orthogonal to each other; and
normal stress sensors including a second diffusion region in the semiconductor substrate.

2. The apparatus of claim 1, wherein each of the first diffusion region is configured to allow a current to flow along a first direction, each of the second diffusion region is configured to allow a current to flow along a second direction, and the first and second directions are angled at 45 degrees from each other.

3. The apparatus of claim 2, wherein the first direction is aligned with a first crystal direction of the semiconductor substrate, and the second direction is aligned with a second crystal direction of the semiconductor substrate.

4. The apparatus of claim 3, wherein the first crystal direction is a [110]-crystal direction, and the second crystal direction is a [100]-crystal direction.

5. The apparatus of claim 1, wherein the first and second diffusion regions have dopants of opposite polarities.

6. The apparatus of claim 1, wherein at least one of the first or second diffusion regions includes a first straight diffusion region, a second straight diffusion region, a third straight diffusion region, and a fourth straight diffusion forming a serpentine resistor.

7. The apparatus of claim 6, further comprising a first metal interconnect coupled between the first and second straight diffusion regions, a second metal interconnect coupled between the second and third straight diffusion regions, and a third metal interconnect coupled between the third and fourth straight diffusion regions, wherein the first, second, and third metal interconnects are over the semiconductor substrate.

8. The apparatus of claim 6, further comprising a first interconnect diffusion region coupled between the first and second straight diffusion regions, a second interconnect diffusion region coupled between the second and third straight diffusion regions, and a third interconnect diffusion region coupled between the third and fourth straight diffusion regions, wherein the first, second, and third interconnect diffusion regions are in the semiconductor substrate.

9. The apparatus of claim 8, wherein each of the first, second, and third interconnect diffusion region has a length and a width larger than a respective width of each of the first, second, and third straight diffusion regions.

10. The apparatus of claim 1, wherein the apparatus is free of metal interconnects over a footprint of the first diffusion regions and a footprint of the second diffusion regions.

11. The apparatus of claim 1, further comprising a reference resistor.

12. The apparatus of claim 11, wherein the reference resistor includes a third diffusion region and a fourth diffusion region angled from each other, the third and fourth diffusion regions having a same length.

13. The apparatus of claim 11, wherein the normal stress sensors are laterally between the reference resistors and the shear stress sensor.

14. The apparatus of claim 1, wherein the shear stress sensor includes:
a first one, a second one, a third one, and a fourth one the first diffusion regions;
a first current terminal coupled to a first end of the first one of the first diffusion regions and a first end of the second one of the first diffusion regions;
a second current terminal coupled to a first end of the third one of the first diffusion regions and a first end of the fourth one of the first diffusion regions;
a first sense terminal coupled to a second end of the first one of the first diffusion regions and a second end of the second one of the first diffusion regions;
a second sense terminal coupled to a second end of the third one of the first diffusion regions and a second end of the fourth one of the first diffusion regions; and
a readout circuit on a periphery of the normal stress sensors and coupled to the first and second sense terminals.

15. The apparatus of claim 14, wherein the first and second sense terminals include, respectively, third and fourth diffusion regions in the semiconductor substrate, each of the third and fourth diffusion regions having a high resistance than each of the first diffusion regions.

16. The apparatus of claim 14, further comprising a first reference resistor and a second reference resistor, wherein the readout circuit includes a first comparator and a second comparator, the first comparator having a first input coupled to the first sense terminal and a second input coupled to the first reference resistor, and the second comparator having a first input coupled to the second sense terminal and a second input coupled to the second reference resistor.

17. The apparatus of claim 1, wherein the normal stress sensors include:
a first one, a second one, a third one, and a fourth one the second diffusion regions on, respectively, a first side, a second side, a third side, and a fourth side of the shear stress sensor;
a first current terminal coupled to a first end of the first one of the second diffusion regions and a first end of the second one of the second diffusion regions;
a second current terminal coupled to a first end of the third one of the second diffusion regions and a first end of the fourth one of the second diffusion regions;
a first sense terminal coupled to a second end of the first one of the second diffusion regions and a second end of the second one of the second diffusion regions;
a second sense terminal coupled to a second end of the third one of the second diffusion regions and a second end of the fourth one of the second diffusion regions; and
a readout circuit on a periphery of the normal stress sensors and coupled to the first and second sense terminals.

18. The apparatus of claim 1, wherein the normal stress sensors are on four sides of the shear stress sensor.

19. The apparatus of claim 1, wherein the shear stress sensor is on a peripheral of the normal stress sensors.

20. The apparatus of claim 1, wherein a thickness of the substrate is less than 50 μm.

21. An integrated circuit comprising:
a semiconductor substrate having:
first and second diffusion regions, the first diffusions region configured to conduct a current along a first direction along a surface of the semiconductor substrate, the second diffusion regions configured to conduct a current along a second direction along the surface, in which the first and second directions are angled from each other, and at least one of the first or second diffusion regions are symmetrical over a first axis and a second axis, the first axis and the second axis are orthogonal to each other; and
a readout circuitry coupled to the first and second diffusion regions and configured to provide signals representing respective resistances of the first and second diffusion regions.

22. The integrated circuit of claim 21, wherein the first diffusion regions are configured to measure out-of-plane stress with respect to the surface, and wherein the second diffusion regions are to configured measure in-plane stress with respect to the surface.

23. The integrated circuit of claim 21, wherein the first direction is aligned with a first crystal direction of the semiconductor substrate, and the second direction is aligned with a second crystal direction of the semiconductor substrate.

24. The integrated circuit of claim 23, wherein the first crystal direction is a [110]-crystal direction, and the second crystal direction is a [100]-crystal direction.

25. The integrated circuit of claim 21, wherein the first and second diffusion regions have dopants of opposite polarities.

26. The integrated circuit of claim 21, wherein the first diffusion regions include a shear stress sensor which includes:
a first one, a second one, a third one, and a fourth one the first diffusion regions;
a first current terminal coupled to a first end of the first one of the first diffusion regions and a first end of the second one of the first diffusion regions;
a second current terminal coupled to a first end of the third one of the first diffusion regions and a first end of the fourth one of the first diffusion regions;
a first sense terminal coupled to a second end of the first one of the first diffusion regions and a second end of the second one of the first diffusion regions; and
a second sense terminal coupled to a second end of the third one of the first diffusion regions and a second end of the fourth one of the first diffusion regions, wherein the first and second sense terminals are coupled to the readout circuitry.
